(19) United States
(12) Patent Application Publication
(10) Pub. No.: US 2024/0166059 A1
(43) Pub. Date: May 23, 2024

(54) Control Device for Operating a Road-Coupled All-Wheel Drive Vehicle

(71) Applicant: Bayerische Motoren Werke Aktiengesellschaft, Muenchen (DE)

(72) Inventor: Florian SCHNAPPAUF, Hattenhofen (DE)

(21) Appl. No.: 18/282,576

(22) PCT Filed: Apr. 8, 2022
(86) PCT No.: PCT/EP2022/059348

§ 371 Date: Sep. 18, 2023

(30) Foreign Application Priority Data
May 12, 2021 (DE) 10 2021 112 443.3

(51) Int. Cl. B60L 15/20; B60K 1/02; B60K 17/354; B60K 17/356

(52) U.S. Cl. CPC B60L 15/2045; B60K 1/02; B60K 17/354; B60K 17/356; B60L 2220/42; B60L 2240/423; B60L 2250/28

(57) ABSTRACT

The invention relates to a control device for operating a road-coupled all-wheel drive vehicle having at least one electronic control unit, having at least a first drive motor as a primary motor assigned to a primary axle and having at least a second drive motor as a secondary motor assigned to a secondary axle. According to the invention, the control unit has a gradient-limiting module for performing a torque gradient limiting function in such a manner that, in the event of a change of the target all-wheel drive factor on the basis of a defined driver's request signal, first the new target all-wheel drive factor is predetermined in a sudden manner and second, in the course of the subsequent adjustment of the all-wheel drive factor, the gradient of the driver's request signal forms the gradient limitation for the maximum admissible adjustment of the torque of the primary motor and/or secondary motor.

### FIELD

The invention relates to a control device for operating a road-coupled all-wheel drive vehicle having at least one electronic control unit, having a first drive motor (in particular a first electric drive motor) assigned to a primary axle (for example, rear axle) and having a second drive motor (in particular a second electric drive motor) assigned to a secondary axle (for example, front axle).

### BACKGROUND AND SUMMARY

For example, DE 10 2014 200 427 A1 makes known a road-coupled hybrid vehicle that includes two different drive units on the particular axle. The different drive units, in particular an internal combustion engine and an electric drive motor, have different dynamic properties; i.e., the target torques are not providable equally quickly at the individual axles. In particular, an increase in torque can be carried out considerably faster by means of an electric drive motor than the same torque increase can be carried out by means of an internal combustion engine. The electronic controller known from DE 10 2014 200 427 A1 deals in particular with problems of these different drive units.

In a road-coupled all-wheel drive vehicle, the primary motor and the secondary motor are not drivingly coupled via a clutch, but rather merely by means of the road via the wheels. Such road-coupled all-wheel drive vehicles are also referred to as “axle-split” vehicles. Such all-wheel drive vehicles are usually operated in a first operating mode (preferably an efficiency-optimized drive mode) solely with the primary motor (single-axle operation) and are also operable as an all-wheel drive vehicle using both drive motors (dual-axle operation) in a second operating mode (preferably a performance-optimized drive mode), in which the secondary motor is automatically switchable on and off.

One problem addressed by the invention is that of improving an all-wheel drive vehicle of the aforementioned type with respect to performance, efficiency, and comfort.

This problem is solved by the features of the independent patent claims. Dependent claims are advantageous enhanced embodiments of the invention.

The invention relates to a control device for operating a road-coupled all-wheel drive vehicle having at least one electronic control unit, having at least a first drive motor (preferably an electric drive motor) as a primary motor assigned to a primary axle and having at least a second drive motor (preferably also an electric drive motor) as a secondary motor assigned to a secondary axle. According to the invention, the control unit has a gradient-limiting module for performing a torque gradient limiting function in such a manner that, in the event of a change in the target all-wheel drive factor on the basis of a defined driver-input signal (=summation driver-input or total target torque), first the new target all-wheel drive factor is abruptly predefined and, second, in the course of the subsequent adjustment of the all—wheel drive factor, the gradient of the driver-input signal forms a gradient limitation for the maximum permissible adjustment of the torque of the primary motor and/or secondary motor.

Preferably, the gradient-limiting module also prevents the direction of the gradient for adjusting the torque of the primary motor in the course of a change in the target all-wheel drive factor from running counter to the direction of the gradient of the driver-input signal. In other words, the torque of the primary motor is not permitted to decrease as the driver-input gradient increases, but rather is held constant, while the torque of the secondary motor is increased until the target all-wheel drive factor is reached. Similarly, the torque of the primary motor is not permitted to increase as the driver-input gradient decreases, but rather is also held constant, while the torque of the secondary motor is reduced until the target all-wheel drive factor is reached.

In the event of a limiting effect of the gradient-limiting module on the adjustment of the torque of the primary motor, in particular, the torque of the secondary motor is held constant.

In one enhanced embodiment of the invention, when the driver-input signal is constant (i.e., at a gradient of zero), the torque of the primary motor and/or of the secondary motor is adjustable, as an exception, with a higher gradient (e.g., +/−20 Nm/dt (dt is, for example, a program-step unit of time or “task”) than that of the driver-input signal.

In particular, according to the invention, as the target all-wheel drive factor increases in the negative torque range, the torque of the primary motor is held constant until the negative torque of the secondary motor has been increased in order to reach the new target all-wheel drive factor.

The invention is based on the following considerations:

The invention relates to an internally tested control device for operating a road-coupled all-wheel drive vehicle having two electric drive motors, in which the driver-input signal is calculated in the form of a summation driver-input (i.e., a total target torque, usually based on a filtered accelerator pedal actuation signal), which is distributed onto the two axles or onto the electric drive motors of the two axles by means of a “fader” (i.e., a fade-over function during a change in the target all-wheel drive factor) by setting the individual torques according to the target all-wheel drive factor. This is the case because road-coupled all-wheel drive systems, as described above (for example, without a transfer gearbox), require a suitable all-wheel drive fade-over function in the event of a change in an all-wheel drive factor.

This internally tested fade-over function (which is explained in greater detail further below in conjunction with FIG. 2) causes uncomfortable jolts, for example, during so-called “tip ins” or during dynamic high torque requirements.

Example: If the all-wheel drive factor is 100% (i.e., 100% of the requested torque is to be applied by the primary motor) and switches during a “tip in” or “punch” (=defined dynamic torque requirement, for example, starting from a coasting condition) to a target all-wheel drive factor of 50%, the target torque of the primary motor on the primary axle (for example, rear axle) would have to “run down” during the “run up” of the total torque by engaging the secondary motor in order to reach the new target all-wheel drive factor (desired distribution) as quickly as possible.

A fader always operates at the same time. The fade-over ultimately takes place based on torque. If the input torque is high, high gradients arise during a fade-over at a consistent fader speed.

In addition, it is possible that, during the load build-up, an axle must briefly run “down”. This is difficult to control specifically for axles driven by an internal combustion engine, since air vibrations in the internal combustion engine must be compensated for.

This internally tested fade-over function is explained once again in other words in FIG. 2, in order to graphically illustrate its disadvantages once again.

These disadvantages are overcome by the control device according to the invention.

According to the invention, the all-wheel drive factor is abruptly changed (“digitally”, for all intents and purposes, with values of 1 or 0) without a fader.

This value therefore “digitally” factors the total driver-input (i.e., the summation driver-input as the total target torque on the basis of the driver-input signal, which is usually determined based on a filtered accelerator pedal actuation signal). This generates a value for the individual axles, which, in the event of a change in the all-wheel drive factor, results in a change in the individual torques of the primary motor and/or the secondary motor. The individual torques are continuously reached via a “rate limiter” (gradient-limiting module for carrying out a torque gradient-limiting function). The rate limiter is defined by a characteristic curve that is dependent upon a driver-input gradient. This characteristic curve is parameterized such that the torque of the primary axle or of the primary motor is not permitted to “run down” as the driver-input gradient increases; for this purpose, according to the invention, the secondary motor is to “run up” and the primary motor is to “remain constant.” In addition, the torque of the primary axle or of the primary motor is not permitted to “run up” as the driver-input gradient is decreasing; for this purpose, according to the invention, the secondary motor is to “run down” and the primary motor is to “remain constant.”

In addition, each axle is never permitted to take on more than the summation load-impact of the driver-input filtering; i.e., the gradient of the individual torque adjustment of the primary motor and/or of the secondary motor is generally not permitted to be greater than the gradient of the driver input. A shift in the direction of a higher gradient (of, for example, +/−20RadNm/task) is permitted only in the range of constant speed (a constant driver-input gradient).

In summary, the aim of the invention is to achieve the following effects:
1. Prevent a faster (individual) torque gradient (in particular in the course of the adjustment of the individual torque of the primary motor) than that of the driver input.
2. Prevent a negative gradient in the course of the adjustment of the individual torque of the primary motor at a positive driver-input gradient.
3. Prevent undefined gradients in the course of a fade-over function depending on the extent of the torque adjustment due to the abrupt (“digital”) change of the target all-wheel drive factor according to the invention instead of a fader having a ramped adjustment of the all-wheel drive factor.

For example, DE 10 2021 105 341, which was not previously published, already describes a control device for operating a road-coupled all-wheel drive vehicle having at least one electronic control unit, having a first electric drive motor (primary motor) assigned to a primary axle and having a second electric drive motor (secondary motor) assigned to a secondary axle. This control unit includes a dynamic function module designed such that, upon detection of a defined dynamic driving mode of the driver on the basis of the driver-input gradient during a (single-axle) operating mode with the primary motor activated and the secondary motor deactivated for a predefined time window, a total target torque curve predefined by the new driver input is ascertained. The total target torque curve is set, in accordance with an axle distribution factor that is also predefined, by reducing the target torque of the primary motor and by activating and increasing the target torque of the secondary motor, even when the predefined total target torque curve is below a maximum possible torque of the primary motor.

A defined dynamic driving mode of the driver is preferably detected on the basis of the driver-input gradient when the current driver-input gradient exceeds a predefined threshold value.

For reasons of efficiency, it can be meaningful in the case of electrified all-wheel drive vehicles to travel for as long as possible in single-axle operation (rear-wheel drive or front-wheel drive). The axle driven in the preferably single-axle operation is referred to as the primary axle.

In a dynamic (“unsteady”) driving mode, it is meaningful for reasons of performance to engage the second axle (secondary axle) early in order to generate a sporty performance response (also referred to as “response” or “punch”) of the vehicle. A dynamic driving mode is detected more particularly on the basis of a steep gradient of the accelerator pedal actuation (also referred to as “tip in”).

In particular after a tip-in detection, the total target torque is set by means of the two electric motors on both axles by means of a predefined axle distribution factor. The target torque of the primary motor is decreased and the target torque of the secondary motor is increased.

Due to the invention, the setting of the total torque no longer solely has the highest priority. Rather, the optimal distribution of the axle torques is also taken into account with respect to efficiency, performance and comfort.

Details of the invention are explained in greater detail in the following exemplary embodiments on the basis of the drawing.

### BRIEF DESCRIPTION OF THE DRAWINGS

FIG. 1 shows a schematic view of a road-coupled electric all-wheel drive vehicle according to various embodiments of the invention including components of the torque-limiting function according to various embodiments of the invention,

FIG. 2 shows a diagram representation of the technical problem of a “fader” without a control device according to various embodiments of the invention,

FIG. 3 shows a diagram representation of one possible approach according to various embodiments of the invention of the problem represented in FIG. 2 without a “fader,” and

FIG. 4 shows a mode of operation of the torque-limiting module in a schematic mathematical representation.

### DETAILED DESCRIPTION

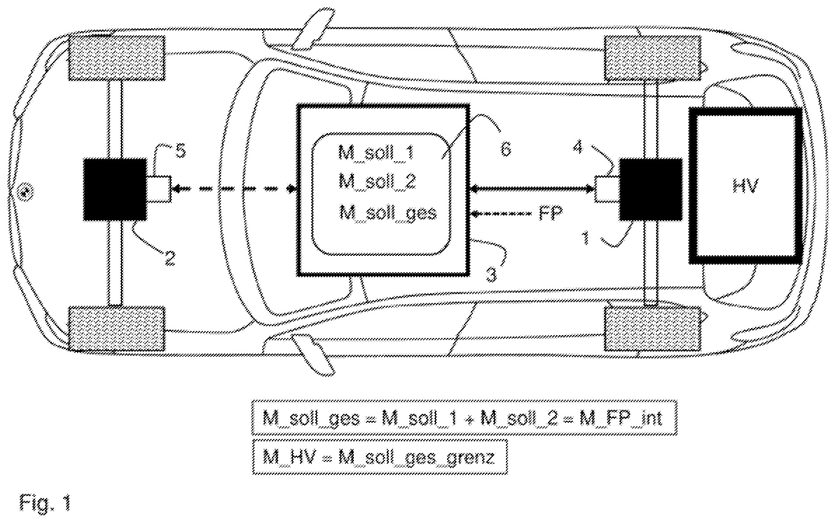

FIG. 1 shows a road-coupled all-wheel drive vehicle having a first electric motor 1 as a primary motor, which acts as a drive motor, for example, on the rear axle PA, and having a second electric motor 2 as a secondary motor, which acts as a drive motor on the front axle SA as a secondary axle in dual-axle operation. The electric motors 1 and 2 are also referred to as electric machines or e-machines. The total output or the total torque of the two e-machines (M_soll_ges=M_soll_1+M_soll_2) is predefined by a filtered driver-input signal FP_int and delimited by the maximum possible output of a high-voltage battery HV: M_HV=M_soll_ges_grenz.

The primary motor 1 can include a separate mechatronically connected sub-control unit 4 and the secondary motor 2 can include a separate mechatronically connected sub-control unit 5. Both sub-control units 4 and 5 are connected to a central electronic control unit 3.

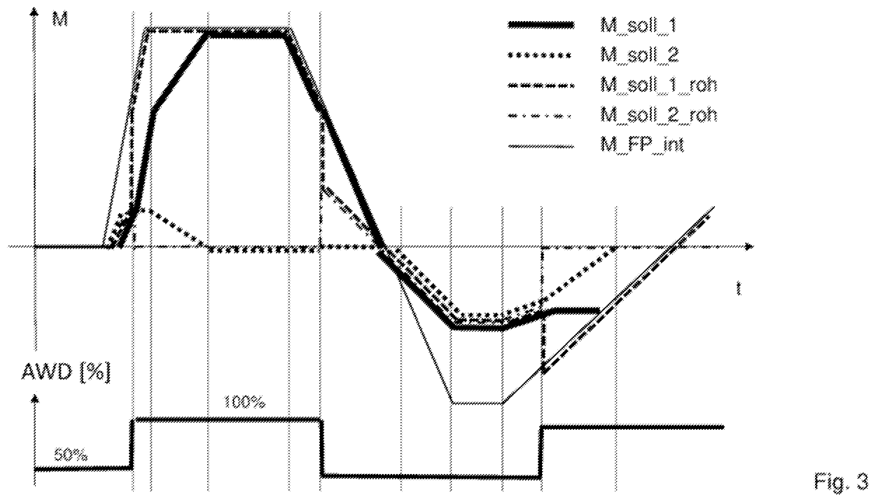

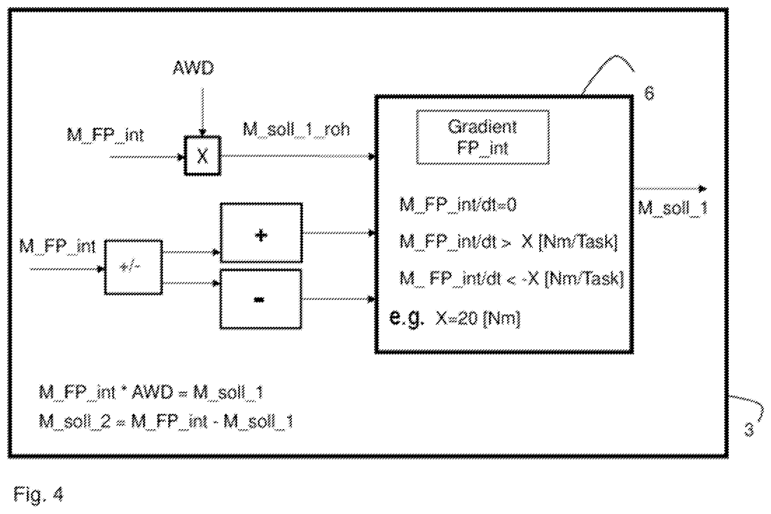

A method for controlling the operation of the electric all-wheel drive vehicle is carried out by the central electronic control unit 3, which includes an appropriate programmable function module 6 and connections to the required sensors, actuators and/or to the sub-control units 4 and 5. According to the present disclosure, a gradient-limiting function module 6 is included in the control unit 3, for example, in the form of a software program (computer program product), the design and mode of operation of which is discussed in greater detail in the description of FIGS. 3 and 4.

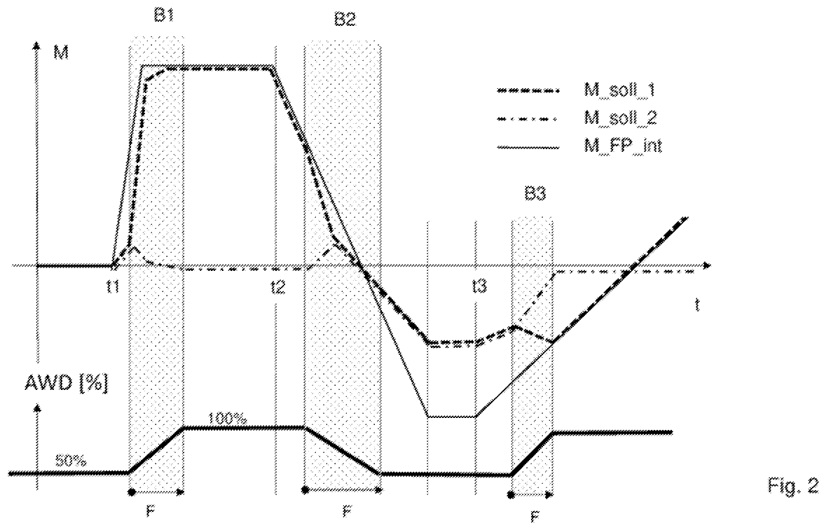

FIG. 2 shows, also representatively for FIG. 3, a diagram with the time t plotted on the x-axis and the torque M plotted on the y-axis. The thin solid line shows an example of one possible curve of the driver-input signal in the form of a filtered summation target torque M_FP_int.

At the point in time t1, a driver-input signal FP_int is plotted in the form of a fast “tip in” having maximum “punch”, i.e., a dynamic total target torque increase having a high gradient, which is predefined by the driver input via the accelerator pedal FP. Therefore, dynamic driver input (a tip-in situation) is detected at the point in time t1 on the basis of the steep gradient of the summation target torque M_FP_int.

Defined dynamic driver input of this type is preferably to be implemented in single-axle operation, i.e., with an all-wheel drive factor AWD of 100%, solely by the torque M_soll_1 of the primary motor 1. A comparatively slow “tip out” takes place at the point in time t2 and a comparatively slow “tip in” takes place at the point in time t3.

A fade-over function F takes place in each of the ranges B1, B2 and B3 at a transition from single-axle operation to dual-axle operation with a predefined all-wheel drive factor AWD of 50%.

As shown in FIG. 2, the above-described disadvantages would arise without the digital gradient-limiting function module 6 according to the present disclosure. For example, the gradient of the torque M_soll_1 of the primary motor 1 in the range B1 at an increasing all-wheel drive factor AWD with the fade-over function F and at an increasing total target torque M_FP_int (“summation driver-input”) would be steeper due to the increasing driver-input signal FP_int than the gradient of the driver-input signal. Similarly, the gradient of the torque M_soll_1 of the primary motor 1 in the range B2 at a decreasing all-wheel drive factor AWD with the fade-over function F and at a decreasing total target torque M_FP_int (“summation driver-input”) would be steeper due to the decreasing driver-input signal FP_int than the gradient of the driver-input signal. In addition, the gradient of the torque M-soll-1 of the primary motor 1 in the range B3 at an increasing all-wheel drive factor AWD with a fade-over function F and at an increasing total target torque M_FP_int (“summation driver-input”) in the negative torque would be opposite to the gradient or the curve of the driver-input signal. Finally, the duration of the fade-over functions F in the ranges 81, 82 and 83 is different and of an undefined length and thus possibly irritating to the driver.

In FIG. 3, the gradient-limiting module 6, in accordance with various embodiments, is explained in greater detail:

Due to an appropriate design or programming according to the present disclosure of the gradient-limiting module 6, a torque-gradient-limiting function is executable in the following way:

In the event of a change in the target all-wheel drive factor AWD due to a defined driver-input signal FP_int or a summation driver-input M_FP_int—for example, in the event of a “tip in” detection—first, the new target all-wheel drive factor AWD is abruptly (without a fader F) predefined. Second, in the course of the subsequent adjustment of the all— wheel drive factor, the gradient of the driver-input signal F_int or of the summation driver-input M_FP_int forms the gradient limitation for the maximum permissible adjustment of the torque M_soll_1 of the primary motor 1. Jumps for unlimited individual torques, as shown with M_soll_1_roh for the primary motor 1 and with M_soll_2_roh for the secondary motor 2, are to be prevented.

The torque M_soll_1 of the primary motor 1 is controlled such that the direction of the gradient for adjusting the torque M_soll_1 of the primary motor 1 in the course of a change in the target all-wheel drive factor AWD does not proceed counter to the direction of the gradient of the driver-input signal FP_int or the summation driver-input M_FP_int.

In the event of a limiting effect of the gradient-limiting module 6 on the adjustment of the torque M_soll_1 of the primary motor 1, the torque M_soll_2 of the secondary motor 2 is held constant.

At a constant driver-input signal FP_int, the torque M_soll_1 of the primary motor 1 and/or the torque M_soll_2 of the secondary motor 2 is adjustable with a higher gradient than that of the driver-input signal FP_int.

As the target all-wheel drive factor AWD increases in the negative torque range, the torque M_soll_1 of the primary motor 1 is held constant until the negative torque of the secondary motor 2 has been increased in order to reach the new target all-wheel drive factor AWD.

The mode of operation of the module 6 is mathematically explained once more with reference to FIG. 4, wherein general examples according to the present disclosure are mentioned once more in other words in the form of bullet points. The target all-wheel drive factor is referred to in short as “AWD factor”, the torque of the primary motor is referred to in short as “pri axle”, and the torque of the secondary motor is referred to in short as “sec axle”:

Case 1: Driver-input gradient M_FP_in/dt=0 (constant speed), AWD factor switches from 1 to 0.5
=>Pri axle is permitted to run down with −20RadNm/task, sec axle is correspondingly permitted to run up with +20 RadNm/task until the distribution according to the AWD factor has been reached.

Case 2: Driver-input gradient M_FP_in/dt>20RadNm (tip in), AWD factor switches from 1 to 0.5
=>Pri axle remains constant with a gradient of 0 RadNm/task
=>Sec axle runs up with the driver-input gradient
=> If the distribution according to the AWD factor has been reached, both axles continue to run with the factored driver-input gradient multiplied by the AWD factor.

Case 3: Driver input gradient M_FP_in/dt<−20 RadNm/task and AWD factor switches from 0.5 to 1
=>Pri axle remains constant, since it would have to run up at a negative gradient
=>Sec axle reduces the torque via the driver-input gradient until it is 0 Nm (distribution=1 has been reached)
=>Thereafter, the pri axle follows the total driver input to an extent of 100%

1-7. (canceled)

8. A control device for operating an all-wheel drive vehicle,
wherein the all-wheel drive vehicle has at least one first drive motor as a primary motor assigned to a primary axle and at least one second drive motor as a secondary motor assigned to a secondary axle,
wherein the control device comprises at least one control unit configured to:
carry out a torque gradient limiting function such that, in response to a change in a target all-wheel drive factor due to a defined driver-input signal, first a new target all-wheel drive factor is abruptly predefined and, second, in the course of a subsequent adjustment of the all-wheel drive factor, a gradient of the driver-input signal forms a gradient limitation for a maximum permissible adjustment of a torque of the primary motor and/or the secondary motor.

9. The control device according to claim 8, wherein the at least one control unit is configured to:
control the torque of the primary motor such that a direction of the gradient for adjusting the torque of the primary motor in the course of a change in the target all-wheel drive factor does not proceed counter to a direction of the gradient of the driver-input signal.

10. The control device according to claim 8, wherein the at least one control unit is configured to:
hold the torque of the secondary motor constant in response to a limiting effect on the adjustment of the torque of the primary motor.

11. The control device according to claim 8, wherein the at least one control unit is configured to:
at a constant driver-input signal, adjust the torque of the primary motor and/or the torque of the secondary motor with a higher gradient than that of the driver-input signal.

12. The control device according to claim 8, wherein the at least one control unit is configured to:
as the target all-wheel drive factor increases in a negative torque range, hold the torque of the primary motor constant until a negative torque of the secondary motor has been increased in order to reach the new target all-wheel drive factor.

13. A non-transitory computer readable medium having stored thereon a program for an electronic control unit that, when executed by the electronic control unit, causes the electronic control unit to perform a method comprising:
carrying out a torque gradient limiting function such that, in response to a change in a target all-wheel drive factor due to a defined driver-input signal, first a new target all-wheel drive factor is abruptly predefined and, second, in the course of a subsequent adjustment of the all-wheel drive factor, a gradient of the driver-input signal forms a gradient limitation for a maximum permissible adjustment of a torque of a primary motor and/or a secondary motor.

14. The non-transitory computer readable medium according to claim 13, wherein the program causes the electronic control unit to perform the method comprising:
controlling the torque of the primary motor such that a direction of the gradient for adjusting the torque of the primary motor in the course of a change in the target all-wheel drive factor does not proceed counter to a direction of the gradient of the driver-input signal.

15. The non-transitory computer readable medium according to claim 13, wherein the program causes the electronic control unit to perform the method comprising:
holding the torque of the secondary motor constant in response to a limiting effect on the adjustment of the torque of the primary motor.

16. The non-transitory computer readable medium according to claim 13, wherein the program causes the electronic control unit to perform the method comprising:
at a constant driver-input signal, adjusting the torque of the primary motor and/or the torque of the secondary motor with a higher gradient than that of the driver-input signal.

17. The non-transitory computer readable medium according to claim 13, wherein the program causes the electronic control unit to perform the method comprising:
as the target all-wheel drive factor increases in a negative torque range, holding the torque of the primary motor constant until a negative torque of the secondary motor has been increased in order to reach the new target all-wheel drive factor.

18. A method for operating an all-wheel drive vehicle,
wherein the all-wheel drive vehicle has at least one first drive motor as a primary motor assigned to a primary axle and at least one second drive motor as a secondary motor assigned to a secondary axle,
the method comprising:
carrying out a torque gradient limiting function such that, in response to a change in a target all-wheel drive factor due to a defined driver-input signal, first a new target all-wheel drive factor is abruptly predefined and, second, in the course of a subsequent adjustment of the all-wheel drive factor, a gradient of the driver-input signal forms a gradient limitation for a maximum permissible adjustment of a torque of a primary motor and/or a secondary motor.

19. The method according to claim 18, comprising:
controlling the torque of the primary motor such that a direction of the gradient for adjusting the torque of the primary motor in the course of a change in the target all-wheel drive factor does not proceed counter to a direction of the gradient of the driver-input signal.

20. The method according to claim 18, comprising:
holding the torque of the secondary motor constant in response to a limiting effect on the adjustment of the torque of the primary motor.

21. The method according to claim 18, comprising:
at a constant driver-input signal, adjusting the torque of the primary motor and/or the torque of the secondary motor with a higher gradient than that of the driver-input signal.

22. The method according to claim 18, comprising:
as the target all-wheel drive factor increases in a negative torque range, holding the torque of the primary motor constant until a negative torque of the secondary motor has been increased in order to reach the new target all-wheel drive factor.
